(19) United States
(12) Patent Application Publication
(10) Pub. No.: US 2024/0036834 A1
(43) Pub. Date: Feb. 1, 2024

(54) Unified Desktop Computing System

(71) Applicant: Bank of America Corporation, Charlotte, NC (US)

(72) Inventors: Sreelatha Sankararaman, Plano, TX (US); James Alexander, Dripping Springs, TX (US); David Smiddy, Chadds Ford, PA (US); Himanshu Goyal, Fort Mill, SC (US); Roy Charlton, III, Monroe, GA (US)

(21) Appl. No.: 17/878,658

(22) Filed: Aug. 1, 2022

(51) Int. Cl. G06F 8/36; H04L 67/133

(52) U.S. Cl. CPC G06F 8/36; H04L 67/133

(57) ABSTRACT

Various aspects of the disclosure relate to a unified framework application programming interface (API) to facilitate communicate between applications developed using different technology stacks. The unified framework API integrates communication functionality for each different technology stacks into unified publication and subscription API functions such that each application calls the unified framework API functions to publish information or to subscribe to receive published information. Each application publishes data using its native communication protocol and receives data in its native format, where the unified framework API performs an automatic translation of the information as needed.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to efficiently, effectively, securely, and uniformly manage use of disparate applications implemented on its computer systems, and particularly manage how internal computer systems exchange information when providing and/or supporting different products and services offered by the organization.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

Aspects of the disclosure relate to computer hardware and software. In particular, one or more aspects of the disclosure generally relate to computer hardware and software for a unified desktop computing framework to normalize communications for associated applications.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes providing a unified communications framework to allow associated applications to communicate via their native protocol(s).

The unified framework allows each individual application (e.g., browser-based applications, .net applications, java-based applications, and the like) to communicate, where the unified framework automatically performs translations between different protocols. The unified framework is easily expanded, and can be changed without modifying the different applications using the unified framework API. The unified framework maps the publication and subscription functions performed by each technology stack to particular API functions. The API does the necessary work to publish content and allow for subscribed content to be communicated. The API performs any required initialization or configuration, when javascript starts, such as when an application framework or application is launched, or when the workstation initializes. In an illustrated example, if an application is configured to publish data within a browser DOM, then the API may handle the event translations so that separate applications built on different technology stacks (e.g., .net, java) can receive any subscribed information, without modifications using a protocol format associated with the particular technology stack. In an illustrative example, the unified framework API may run as a set of javascript libraries in a web browser. The web application may initialize the javascript functionality. For non-browser based applications, the API may be used with a number of communication protocol formats, such as those provided via .dlls included when the application is compiled.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for a unified communications framework, in accordance with one or more aspects described herein;

FIG. 1B shows an illustrative computing platform enabled for providing a unified communications framework, in accordance with one or more aspects described herein;

FIG. 2 show an illustrative process to provide a unified communications framework, in accordance with one or more example arrangements; and

FIG. 3 shows an illustrative example of a unified communications framework, in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

Associates working for enterprise organizations often access multiple applications to provide products and services to customers, via a networked connections (e.g., a contact center) or in-person communications (e.g., at a financial center or other business location). Often, these applications have been developed by different groups or vendors or at different times. As such, the applications may be written in various technology stacks or computing languages (e.g., Web/JavaScript, .Net, Java, and the like). Often, information must be exchanged between these disparate applications to optimize a customer experience and/or to provide a particular service or services to the customer. As such, these applications need to communicate with each other to optimize associate performance and minimize effort and/or errors from retyping and/or cut and pasting of data. Providing a unified desktop to tens of thousands of associates allows the business organization to provide better, and more reliable, services to their customers.

In some cases, many of these applications may be developed to operate within a web browser environment. Often, due to browser restrictions, web applications can not directly communicate to external applications outside the browser's single Document Object Model (DOM), an application programming interface (API) for hypertext markup language (HTML) and extensible markup language (XML) documents. As such, several frameworks may be used for inter-process communication (IPC). However, each require a unique set of APIs that make integration difficult due to ensuring proper management of API integration logic with the various applications. Examples of IPC integrations that may be used in current installations include, but are not limited to asynchronous messaging protocols such as a publication and subscription (pub/sub) messaging that may support web applications running within a single instance of a Web Browser document object model (DOM); desktop framework messaging protocols based on active x technologies supporting web applications across multiple DOMs and/or a local desktop environment; proprietary software framework environment messaging protocols such as for .net applications, open-source cross platform java script run-time environment messaging protocols (e.g., node.JS) for supporting web applications across multiple DOM's and local desktop Java based applications; and a client experience workstation (CEW) communications that may be based on proprietary and/or opensource functionalities for supporting web applications across multiple DOM's.

In an illustrative system, associates of a business organization may log into a container, which integrates several applications based on what the user permission and/or security level. Events may be published and subscribed by the different local and/or network applications integrated with the container. The system may integrate a common library (e.g., a common java script library and/or initialization configurations that abstracts the web application or web application interface from each IPC. Here, each implementation may utilize a single set of JavaScript API's that allows content to be published by one application and subscribed by another application, thus allowing the applications to publish and receive messages in their native “language”. In doing so, the framework and integrated API provides an updateable and centralized “one-stop shop” for application servicing. Applications utilize their current event “language” or messaging protocols, thus eliminating a need to standardize communications to a current or past messaging format, as the API may be updated as needed to extend support to additional messaging protocols, which reduces costs, improves time to market and reduces support infrastructure in both technology and human costs.

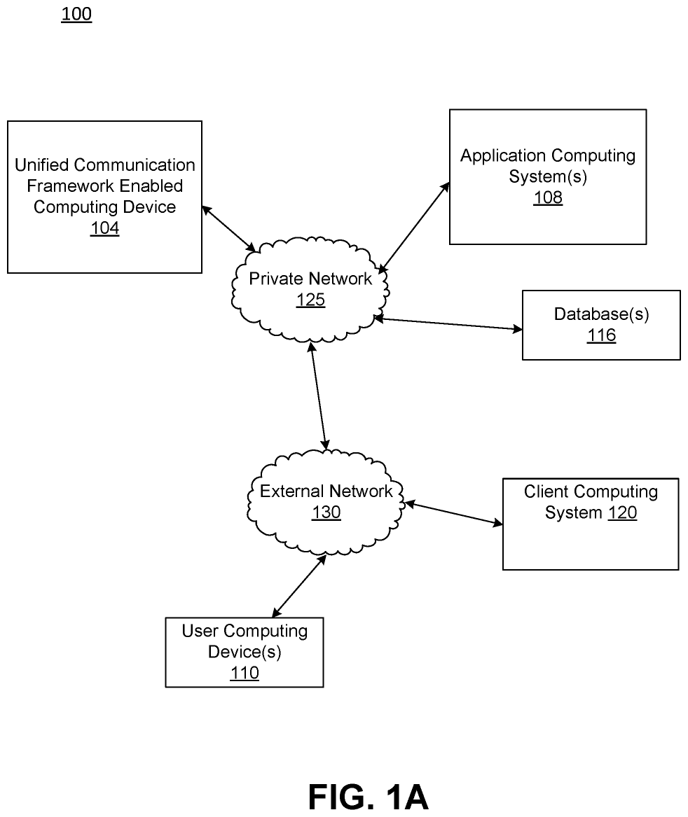

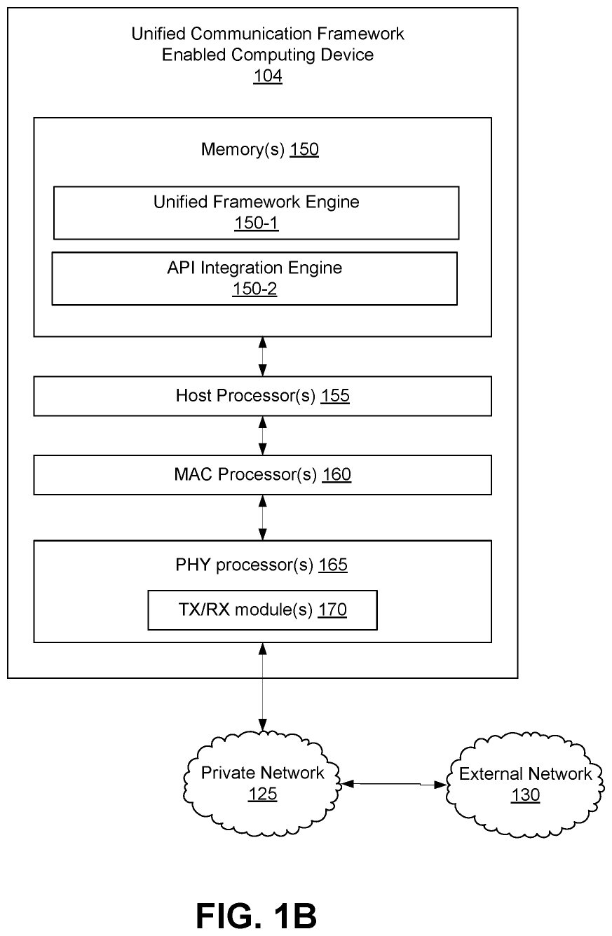

FIG. 1A shows an illustrative computing environment 100 for providing a unified communications framework in accordance with one or more arrangements. The computing environment 100 may comprise one or more devices (e.g., computer systems, communication devices, and the like). The computing environment 100 may comprise, for example, a unified communication framework computing system 104, one or more application system(s) 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the unified communication framework computing system 104 as a single computing framework system, aspects of the unified communication framework system may be implemented as a separate computing system.

The unified communication framework computing system 104 may comprise one or more computing devices and/or other computer components (e.g., processors, memories, communication interfaces) configured to perform one or more functions as described herein. Further details associated with the architecture of the unified communication framework computing system 104 are described with reference to FIG. 1B.

The application computing systems 108 and/or the client system 122 may comprise one or more computing devices and/or other computer components (e.g., processors, memories, communication interfaces). In addition, the application computing system 108 and/or the client system 120 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing system 120 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing system 120 and/or the application computing systems 108 may comprise various servers and/or databases that store and/or otherwise maintain account information, such as financial account information including account balances, transaction history, account owner information, and/or other information. In addition, the client computing system 120 and/or the application computing systems 108 may process and/or otherwise execute transactions on specific accounts based on commands and/or other information received from other computer systems comprising the computing environment 100. In some cases, one or more of the client computing system 120 and/or the application computing systems 108 may be configured, for example, to host, execute, and/or otherwise provide one or more transaction processing programs, such as electronic fund transfer applications, online loan processing applications, and/or other programs associated with the financial institution. While the client computing system 120 is shown communicating via an external network 130, the client computing system 120 may also be capable of communicating via the private network 124, in some cases.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing system 120 may comprise one or more computing devices and/or other computer components (e.g., processors, memories, communication interfaces). The client computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing system 120 is for processing an electronic exchange of goods and/or services. The client computing system 120 may be associated with a specific goods purchasing activity, such as purchasing a vehicle, transferring title of real estate may perform communicate with one or more other platforms within the client computing system 120. In some cases, the client computing system 120 may integrate API calls to request data, initiate functionality, or otherwise communicate with the one or more application computing systems 108, such as via the services 109. For example, the services 109 may be configured to facilitate data communications (e.g., data gathering functions, data writing functions, and the like) between the client computing system 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the unified communication framework 104. For example, the database(s) 116 may store API code of an API used to communicate between applications and/or application computing systems, API translation classes, and the like. In an arrangement, the database(s) 116 may be used for other purposes as described herein. In some cases, the unified communication framework 104, the client computing system 120, the application computing systems, and/or other computing systems (e.g., a software development computing system) may write data or read data to the database(s) 116 via the services.

In one or more arrangements, the unified communication framework, the application systems 108, the databases 116, the client computing system 120, the user devices 110, and/or the other devices/systems in the computing environment 100 may be any type of computing device capable of receiving input via a user interface, and communicating the received input to one or more other computing devices in the computing environment 100. For example, the unified communication framework, the application systems 108, the databases 116, the client computing system 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the unified communication framework, the application systems 108, the databases 116, the client computing system 120, the user devices 110, and/or the other devices/systems in the computing environment 100 may, in some instances, be and/or comprise special-purpose computing devices configured to perform specific functions.

FIG. 1B shows an illustrative unified communication framework 104 in accordance with one or more examples described herein. The unified communication framework 104 may be a stand-alone device and/or may at least be partial integrated with the development computing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The unified communication framework 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the unified communication framework 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 155. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the unified communication framework 104 may be configured to execute machine readable instructions stored in memory 150. The memory 150 may comprise (i) one or more program modules/engines having instructions that when executed by the one or more processors cause the unified communication framework 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the unified communication framework 104 and/or by different computing devices that may form and/or otherwise make up the unified communication framework 104. For example, the memory 150 may have, store, and/or comprise a unified framework engine 150-1, and an API integration engine 150-2, and/or the like. The unified framework engine 150-1 may have instructions that direct and/or cause the unified communication framework 104 to perform one or more operations associated with operating multiple web applications within a similar framework, regardless of the technologies used to implement each web application, and to provide a common communication interface for communicating between applications both within the framework and outside of the framework. The API integration engine 150-2 may have instructions that may cause the unified communication framework 104 to enable operation of common API interface functions to communicate between different applications having different communication protocols that are dependent upon the technology platform upon which each application is based. The API integration engine 150-2 may be extendible or upgradable to allow for future integration of applications developed on different platforms whose communication protocols may not be natively compatible with the platforms upon which different applications are based.

While FIG. 1A illustrates the unified communication framework 104 and/or the application systems 108, as being separate elements connected in the private network 125, in one or more other arrangements, functions of one or more of the above may be integrated in a single device/network of devices. For example, elements in the unified communication framework 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application systems 108.

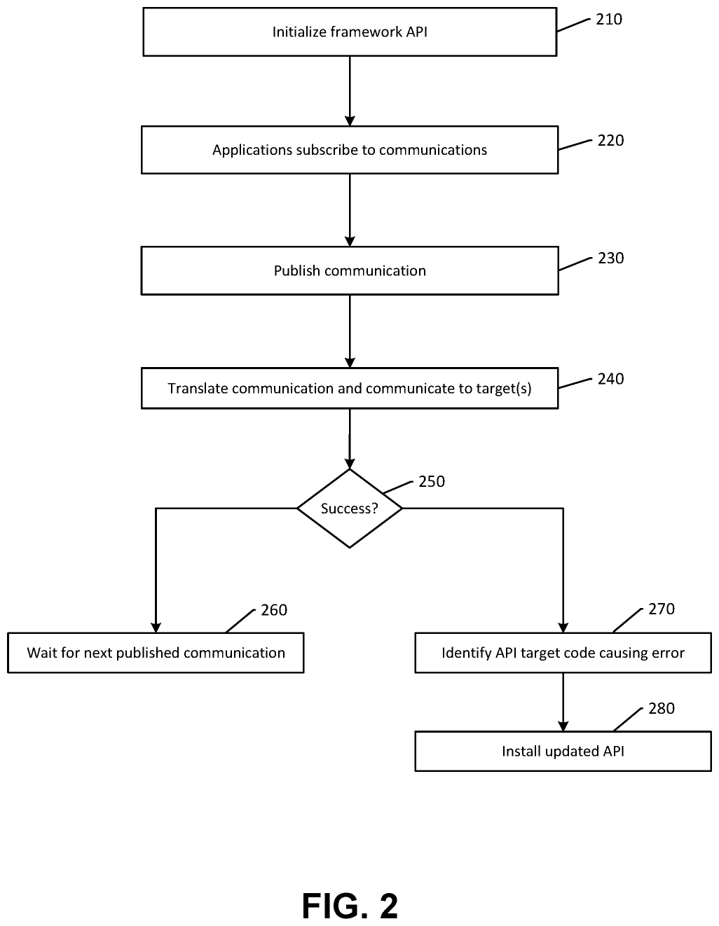

FIG. 2 shows an illustrative process for operation of the unified communication framework 104, in accordance with one or more example arrangements. At 210, a unified framework may activate a communications API including functions that may be integrated into one or more applications and/or communications interface to manage communicates between applications developed using multiple technologies. For example, the API may allow an application to send and receive communications in its native format, without needing to integrate multiple different APIs. At 220, the applications integrated into the unified framework and/or external applications may subscribe to output provided by one or more other applications associated with the unified framework, either running internal to the framework or operating external to the framework. At 230, an application may publish information via the API, such as using a publish data function call. To the application, the information is published as originally designed, where the data is then managed by the unified framework. At 240, the unified framework may translate the data and communicate the published data to the subscribing applications via the API. At 250, success of the publishing functionality is checked. If the publishing/subscribing operation completes correctly, the unified framework 260 waits for the next publication or communication event at 260. If, at 250, an error is identified, the unified framework may automatically debug the operation and/or may collect error indications from the affected applications at 270. Once identified, at 280, the API may be updated with improved functions and installed in the unified framework. Additionally, one or more applications affected by the improved functionality may utilize new or updated API functions, where the new API may be activated in the unified framework at 210.

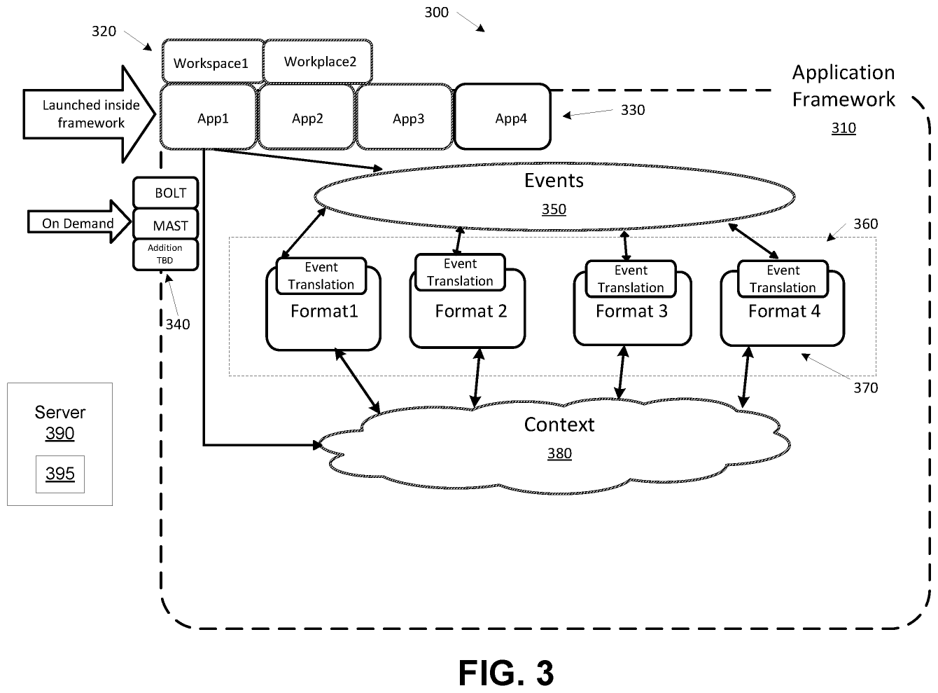

FIG. 3 shows an illustrative example of a unified communications framework 360 as used within an application framework on a user computing device, in accordance with one or more aspects described herein. The user computing device may be a computing device operating on the enterprise computing network of a business organization. In some cases, the user of the user computing device may access one or more applications 330 via an application framework 310 to provide products and/or services to a client. For example, the user may be an associate in a banking center accessing one or more banking applications to provide services to the client. In some cases, each application 330 may be developed separately and may need to share information to improve overall operation performance of the computing device. For example, customer information (e.g., account information, security information, and the like) may be shared by the applications based on, for example, a customer identifier. Additionally, the user computing device may operate one or more workspaces 320, where each workspace may include one more application frameworks, such as the application framework 310. In an illustrative example, the application framework 310 may be a web browser, where each of a number of applications may operate within the browser environment. In some cases, the application framework 310 may be a custom developed framework operating as a stand-alone environment in which a number of applications are run.

As mentioned the application framework 310 may operate within a browser based environment or a stand-alone environment supporting operation of one or more applications 330. The applications 330 may be developed using a number of technologies, where each technology may have a communication interface natively incompatible with the communication interface of another technology, such as java, java script, .Net, and the like. In some cases, each technology used for development of the application and/or frameworks may include a separate API to support inter-application communications. Each of these APIs may require separate development time to incorporate the API function calls to facilitate the supported communications. As shown, the one or more applications 330 may be launched within the application framework 310. In some cases, other separate applications may share information or otherwise communicate with the applications 330 via a communication interface 340 of the application framework, where the communication interface 340 may allow for on-demand communication (e.g., publication of data, subscriptions to data, and the like) to and from the external application, such as via different communication protocols (e.g., bolt, and the like). For example, for external database centric applications, the bolt protocol may be used.

To facilitate communication between the different applications 330 and/or external applications via the communication interface 340, each application may share data via events 350 (e.g., a publication event), where the unified framework API 360 may identify the native language format and translate the publication event into other data formats to provide context 380 for the applications subscribing to these events. For example, if a first application (e.g., a browser based application publishing information within the browser's DOM) applications within the same DOM may receive any subscribed information directly. For other applications subscribing to this information, the unified framework API 360 may translate the publication event into an event format for one or more different technology stacks, such as .Net, java script, and the like. To do so, each application may integrate the unified framework application functions for sharing information (e.g., publication, subscription, and the like) once. The unified framework API may integrate the event translation functionality into its API functions, so that for any existing technology stack, or future developed technology stack, only the unified framework API needs to be updated, not the applications themselves. During initialization of the user computing device operating framework 310 that integrates the unified framework API, the API library 395 may be retrieved and loaded from an external server (e.g., a web server).

The unified framework may be used to synchronize content between applications, such as to allow a business user to load customer information in one application, and easily share information associated with that customer between different applications, to provide a unified and coordinated experience for both the business user and the customer. In doing so, inadvertent errors introduced by mistyping information, cut and paste errors may be minimized, while simultaneously speeding up the customer experience.

To share information between different applications, some form of inter-process communications is necessary, such as a communication bridge. These bridges allow applications to communicate, such as via a publication/subscription format. Often, such communication bridges are built on APIs. In many cases, each application, or technology stack upon which each application is based, requires a different API for the communication. In these cases, the APIs may be specifically coded for the particular application or technology stack, as such, multiple APIs must be integrated into each application, so that communication can occur. This means, each time a new application is developed or launched on a previously unsupported technology stack, new API function calls must be hard-coded into each application so that the new application can communicate with the existing infrastructure. This adds complexity to the interfaces leading to a greater potential to introduce code errors and bugs into the application. Additionally, the code changes require additional development time, which may be specifically problematic for older applications.

The unified framework API creates an abstraction layer using a common software language (e.g., javascript) to abstract the different communication frameworks from the application. The unified framework allows for use of 1 API for inter-process communications, where each application remains agnostic to a format required for other applications. Each application publishes information or receives information in their native format, without additional coding, while the unified framework API handles any translation required. As such, development costs are reduced and communication errors are reduced.

Each application includes the unified framework API function calls to share information. Using the unified event library functions integrated into the API, each application can communicate within other applications regardless of the technology stack, such that each application can automatically synchronize, without requiring a user to search between different applications.

The library provides common functionality that may be set up during initialization of each computer device utilizing the API. The API operation is primarily to facilitate inter-application communication on a single workstation, such as a client support work station. The library utilizes a single set of APIs that may be written in a common language (e.g., javascript) to allow for publication and subscription functionalities. Regardless of the inter-process communications used by each application, only the single API is needed. As additional technology stacks are used, the communication requirements can be added to the library.

The unified framework allows each individual application (e.g., browser-based applications, .net applications, java-based applications, and the like) to communicate, where the unified framework automatically performs translations between different protocols. The unified framework is easily expanded, and can be changed without modifying the different applications using the unified framework API. The unified framework maps the publication and subscription functions performed by each technology stack to particular API functions. The API does the necessary work to publish content and allow for subscribed content to be communicated. The API performs any required initialization or configuration, when javascript starts, such as when an application framework or application is launched, or when the workstation initializes. In an illustrated example, if an application is configured to publish data within a browser DOM, then the API may handle the event translations so that separate applications built on different technology stacks (e.g., .net, java) can receive any subscribed information, without modifications. In an illustrative example, the unified framework API may run as a set of javascript libraries in a web browser. The web application may initialize the javascript functionality. For non-browser based applications, the API may be used with .dlls included when the application is compiled.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a computing device hosting a unified API function library;
a workstation, comprising:
at least one processor; and
memory storing computer-readable instructions that, when executed by the at least one processor, cause the workstation to:
initialize a unified framework API based on the unified API function library;
receive, from a first application, a publication event in a first protocol format;
translate, by a unified framework, the publication event to at least a second protocol format; and
publish, by the unified framework, the publication event in the second protocol format.

2. The system of claim 1, wherein the instructions cause the workstation to publish the publication event in both the first protocol format and the second protocol format.

3. The system of claim 1, wherein the first protocol format comprises a document object model (DOM) format.

4. The system of claim 2, wherein the first protocol format comprises a javascript communications format.

5. The system of claim 1, wherein the first application and a second subscribing application integrates the unified API function calls.

6. The system of claim 1, wherein updates to the unified API function library hosted by the computing device are applied during initialization of the workstation.

7. An apparatus comprising:
a communication interface linked to an external computing device hosting a unified API function library;
at least one processor; and
memory storing computer-readable instructions that, when executed by the at least one processor, cause the apparatus to:
initialize a unified framework API based on the unified API function library;
receive, from a first application, a publication event in a first protocol format;
translate, by a unified framework, the publication event to at least a second protocol format; and
publish, by the unified framework, the publication event in the second protocol format.

8. The apparatus of claim 7, wherein the instructions cause the apparatus to publish the publication event in both the first protocol format and the second protocol format.

9. The apparatus of claim 7, wherein the first protocol format comprises a document object model (DOM) format.

10. The apparatus of claim 7, wherein the first protocol format comprises a javascript communications format.

11. The apparatus of claim 7, wherein the first application and a second subscribing application integrates the unified API function calls.

12. The apparatus of claim 7, wherein updates to the unified API function library hosted by the external computing device are applied during initialization of the apparatus.

13. The apparatus of claim 7, wherein support for a third protocol format comprises updating the unified API function library to translate from the first protocol format or the second protocol format to the third protocol format.

14. Non-transitory memory storing computer-readable instructions that, when executed by at least one processor, cause a computing device to:
initialize a unified framework API based on a unified API function library;
receive, from a first application, a publication event in a first protocol format;
translate, by a unified framework, the publication event to at least a second protocol format; and
publish, by the unified framework, the publication event in the second protocol format.

15. The non-transitory memory of claim 14, wherein the instructions cause the computing device to publish the publication event in both the first protocol format and the second protocol format.

16. The non-transitory memory of claim 14, wherein the first protocol format comprises a document object model (DOM) format.

17. The non-transitory memory of claim 14, wherein the first protocol format comprises a javascript communications format.

18. The non-transitory memory of claim 14, wherein the first application and a second subscribing application integrates the unified API function calls.

19. The non-transitory memory of claim 14, wherein updates to the unified API function library hosted by an external computing device are applied during initialization of the computing device.

20. The non-transitory memory of claim 14, wherein support for a third protocol format comprises updating the unified API function library to translate from the first protocol format or the second protocol format to the third protocol format.
